(19) United States
(12) Patent Application Publication
(10) Pub. No.: US 2020/0307056 A1
(43) Pub. Date: Oct. 1, 2020

(54) POLYMERIC PRODUCTS HAVING LAYER-LIKE MORPHOLOGY FORMED FROM MASTERBATCHES

(71) Applicant: LYONDELLBASELL ADVANCED POLYMERS INC., HOUSTON, TX (US)

(72) Inventors: KARI MACINNIS, COPLEY, OH (US); GUOJUN ZHANG, SOLON, OH (US)

(73) Assignee: LYONDELLBASELL ADVANCED POLYMERS INC., HOUSTON, TX (US)

(21) Appl. No.: 16/755,331

(22) PCT Filed: Oct. 10, 2018
(86) PCT No.: PCT/US2018/055133

§ 371 Date: Apr. 10, 2020

Related U.S. Application Data
(60) Provisional application No. 62/570,504, filed on Oct. 10, 2017.
(60) Provisional application No. 62/598,774, filed on Dec. 14, 2017.
(60) Provisional application No. 62/668,046, filed on May 7, 2018.

(51) Int. Cl. B29C 48/00; B29C 48/21; B32B 27/08; B32B 27/32; B32B 27/30; B32B 27/36; B32B 27/34

(52) U.S. Cl. CPC B29C 48/022; B29C 48/21; B32B 27/08; B32B 27/32; B29K 2101/00; B32B 27/36; B32B 27/34; B32B 27/306; B32B 27/304

(57) ABSTRACT

Disclosed herein are polymeric products, along with masterbatches and methods of making polymeric films, sheets, and extruded articles from the masterbatches, in which the films and polymeric products exhibit layer-like morphology and retain good barrier properties to a permeant of interest. The masterbatches include one or more structural and barrier polymers and a compatibilizer.

### CROSS-REFERENCE TO RELATED APPLICATIONS

This application claims priority from U.S. provisional application 62/570,504 filed on Oct. 10, 2017; from U.S. provisional application 62/598,774 filed Dec. 14, 2017; and from U.S. provisional application 62/668,046 filed May 7, 2018. The entire content of each of these provisional applications is hereby incorporated by reference into this application.

### TECHNICAL FIELD

The present disclosure relates to novel polymeric products having layer-like morphology and exhibiting improved properties, such as good barrier properties, formed from one or more masterbatches.

### BACKGROUND

Tailoring the physical properties of polymeric products (e.g., films, sheets, or articles) is important for any number of applications. For example, it is important to have good barrier properties in products such as barrier films. A main purpose of barrier film is to inhibit or prevent permeation of a permeant (such as a liquid, gas, vapor, small molecules or oligomers) therethrough. A non-limiting list of permeants includes oxygen, carbon dioxide, nitrogen, methane, moisture vapor, gasoline vapors, flavorants, fragrances, greases, oils, inks, volatile components of chemicals, etc.

In one particular example, barrier films may be used as packaging films. Packaging films contain and protect products for distribution, storage, sale and use, and packaging often serves to transmit information about products, market products and provide security for products. As such, packaging is very important in our consumer-based society.

A non-limiting list of other barrier product applications may include, for example, various flexible or rigid articles, such as agricultural films (fumigation, mulch, silage), industrial films, tubing (medical or automotive), pipes, caps, closures, food, beverage, industrial, healthcare, pharmaceutical or cosmetic packages, pouches, containers, bottles, tanks, etc.

Currently, a number of approaches are used to address the issue of improving physical properties, such as gas and small molecule permeability. However, many of these approaches produce less-than-desired results or require high-cost materials and/or complex and costly manufacturing processes and/or the use of environmentally or physiologically undesirable components.

For example, one conventional approach is to blend two or more miscible or immiscible polymeric components—without regard to morphology—to produce a simple composition that exhibits physical properties that are different from those of the components. The composition may then be used to form products (e.g., films, sheets, or articles such as packages, tubing, tanks, pipes, containers, bottles, etc.) having physical properties that are different than the physical properties that could be obtained from using unblended components. In many cases, a component that exhibits relatively good performance in one or more physical properties, such as a component with a high barrier characteristic, is blended with one or more components that may not have good barrier performance, but may perform other functions (such as lowering cost or providing other, different physical property benefits, such as for example, structure). Unfortunately, such a conventional approach often does not result in maximum desired performance (e.g., increasing the barrier property/lowering permeability).

Another conventional approach is to produce a multilayered product via coextrusion or lamination (e.g., film, sheet or article such as packages, tubing, tanks, pipes, containers, bottles, etc.), wherein each layer is discrete and has a dedicated function. The multilayered structure allows for products that may have different (and in some cases, improved) physical properties as compared with a product formed from a single layer or a blend.

Using the example of a coextruded barrier film, one layer may function as an oxygen barrier, another layer may function as a moisture barrier, another layer may provide good cold seal adhesion and still another layer may facilitate printing. In addition to these layers, one or more tie layers may be needed to enable some of the adjoining layers to adhere to each other sufficiently to avoid delamination. Needless to say, the use of tie layers increases the cost of the product. In order to form such a multifunctional, multi-layer film, a complex arrangement of extruders is therefore often required. Indeed, the number of extruders that is required typically corresponds to the number of discrete layers being formed. Because many product manufacturers cannot afford such complex equipment to provide packages, tubing, tanks, pipes, containers, bottles, etc., they are forced to sacrifice desirable functionality in order to provide economical packaging.

Based on the foregoing, there remains a need for relatively inexpensive and easy to manufacture packaging, industrial, or agricultural materials (such as, e.g., films, packages, tubing, tanks, pipes, containers, bottles, etc.) that have good barrier properties.

### SUMMARY OF THE EMBODIMENTS

Disclosed herein are novel methods of forming a polymeric body that has enhanced barrier properties. A masterbatch is provided comprising from 30 to 70 weight percent of a structural polymer, from 30 to 70 weight percent of a barrier polymer for the permeant of interest, and from about 3 to about 10 weight percent of functionalized polyolefin. The masterbatch is melted in a first heated extruder and extruded to form the polymeric body, wherein the polymeric body possesses a layer-like morphology. In one embodiment, the polymeric body comprises a first barrier film layer, wherein the melted masterbatch is extruded through a die to form a first molten polymer extrudate, and wherein the first molten polymer extrudate is cooled and thinned to form the first barrier film layer having layer-like morphology.

In one or more embodiments, the polymeric body is selected from the group consisting of a packaging film, a film for packaging food, a film for packaging pharmaceutical or healthcare products, a lidding film, an agricultural film, an industrial film, a tubing, a pipe, a cap, a closure, a film for silage, a film for fumigation or mulch, a three dimensional body, a container, a bottle, a pouch, a tank, and a package for food, beverage or for an industrial, pharmaceutical or cosmetic product.

Disclosed herein are novel methods of forming barrier film for a permeant of interest. A masterbatch is provided comprising from 30 to 70 weight percent of a structural polymer, from 30 to 70 weight percent of a barrier polymer, and from about 3 to about 10 weight percent functionalized polyolefin. The masterbatch is melted in a heated extruder and passed through a die to form a molten polymer extrudate. The molten polymer extrudate is cooled to form a barrier film having layer-like morphology.

In an embodiment, the barrier film is a multilayer barrier film, and the method further comprises providing a second polymer, melting the second polymer in a second heated extruder, and coextruding the melted masterbatch and the melted second polymer through the die to form a molten multilayer polymer extrudate. The molten multilayer polymer extrudate is then cooled to form the multilayer barrier film comprising the first barrier film layer and a second layer, wherein the first barrier film layer has a layer-like morphology. In an embodiment, the second polymer is selected from the group consisting of polyolefins, polyamides, polyesters, polystyrene, polylactic acid, polyhydroxyalkanoate (PHA) and combinations thereof. In a particular embodiment, wherein the structural polymer comprises polypropylene homopolymer or copolymer and wherein the cooling of the molten multilayer polymer extrudate forms an unstretched barrier film, the method further comprises biaxially stretching the unstretched barrier film to form a stretched barrier film that has a thickness that is less than the thickness of the unstretched barrier film, and the stretched barrier film possesses layer-like morphology.

In one or more particular embodiments of any of the foregoing, the structural polymer is selected from a group consisting of polyolefins, polyesters, polystyrene, polylactic acid, polyhydroxyalkanoate (PHA) and combinations thereof, and the barrier polymer is selected from a group consisting of copolymers of ethylene vinyl alcohol, polyvinyl alcohol, polyvinylidene chloride, polyamides, nitrile polymers and combinations thereof. More particularly, the structural polymer comprises a polyolefin and the barrier polymer comprises a copolymer of ethylene vinyl alcohol. In a particular embodiment, the polyolefin is selected from a group consisting of polyethylene, polypropylene, copolymers of ethylene with one or more alpha-olefins or copolymers of ethylene with one or more vinyl esters, copolymers of polyethylene or polypropylene, or combinations thereof. In a particular embodiment, the polyolefin comprises a low density polyethylene, a linear low density polyethylene, a medium density polyethylene, a high density polyethylene, an ethylene vinyl acetate, an ethyl methyl acrylate, an ethylene butyl acrylate, or a polypropylene homopolymer, bipolymer or terpolymer, or combinations thereof.

In one or more particular embodiments, the permeant is oxygen, the masterbatch comprises from 35 to 65 weight percent of the structural polymer, from 35 to 65 weight percent of the barrier polymer, and from 5 to 10 weight percent of the functionalized polyolefin. In a particular embodiment, the polyolefin structural polymer comprises high density polyethylene or polypropylene homopolymer, or combinations thereof, and the functionalized polyolefin is selected from a group consisting of copolymers of ethylene and/or propylene and one or more unsaturated polar monomers, and polyolefins that are graft-modified with a maleic acid or a maleic anhydride. In a particular embodiment, the ethylene vinyl alcohol copolymer has an ethylene content of greater than 24 mole % and the functionalized polyolefin comprises polyethylene, linear low density polyethylene, medium density polyethylene, or high density polyethylene that is graft-modified with a maleic acid or a maleic anhydride.

Disclosed herein is a novel polymeric body having enhanced barrier properties to a permeant of interest. The body comprises from 30 to 70 weight percent structural polymer, from 30 to 70 weight percent barrier polymer for the permeant of interest, and from about 3 to about 10 weight percent functionalized polyolefin, wherein the body possesses layer-like morphology. In one or more embodiments, the polymeric body may be packaging film, a film for packaging food, an agricultural film, an industrial film, a tubing, a pipe, a cap, a closure, a film for silage, a three dimensional body, a container, a bottle, a pouch, a tank, or a package for food, beverage or for an industrial, pharmaceutical or cosmetic product.

In one or more embodiments, the polymeric body is a barrier film. More specifically, in one or more embodiments the barrier film comprises from 35 to 65 weight percent structural polymer, from 35 to 65 weight percent barrier polymer, and from 5 to 10 percent of functionalized polyolefin.

Disclosed herein is a novel multilayer barrier film having a first layer comprising from 35 to 65 weight percent structural polymer, from 35 to 65 weight percent barrier polymer, and from 5 to 10 percent of functionalized polyolefin, along with a second layer comprising a second polymer, wherein the first layer possesses layer-like morphology. In one or more embodiments, the second polymer is selected from the group consisting of polyolefins, polyamides, polyesters, polystyrene, polylactic acid, and combinations thereof.

### BRIEF DESCRIPTION OF THE DRAWINGS

The present disclosure, in accordance with one or more various embodiments, is described in detail with reference to the following drawings. The drawings are provided for purpose of illustration only and merely depict aspects of typical or example embodiments. These drawings are provided to facilitate the reader's understanding of the disclosure and shall not be considered limiting of the breadth, scope, or applicability of the disclosure.

The components in the drawing are not necessarily drawn to scale. In the drawings, like reference numerals designate corresponding parts throughout the several views. One of ordinary skill in the art will appreciate that a component may be designed as multiple components or that multiple components may be designed as a single component.

FIG. 1A shows cross sectional views of extruded packaging films having five different blend morphologies, viewed at/from a plane transverse to the direction of extrusion.

FIG. 1B shows cross sectional views of two extruded packaging films having two different morphologies, viewed at/from a plane parallel to the direction of extrusion.

FIGS. 2A and 2B shows a plot of blend and series model permeability values for 2-component, LLDPE/EVOH and HDPE/EVOH barrier films, respectively.

FIG. 2C illustrates a cross section AFM image of the films plotted in FIG. 2A, viewed at/from a plane parallel to the direction of extrusion.

FIGS. 3A and 3B show plots of blend and series model permeability values for 3-component barrier films.

FIGS. 3C and 3D illustrate cross section AFM images of the films plotted in FIGS. 3A and 3B, respectively, viewed at/from a plane parallel to the direction of extrusion.

FIGS. 4A and 4B illustrate cross section AFM images of a blown multilayer film described herein, viewed at/from a plane parallel to the direction of extrusion.

FIGS. 5A and 5B illustrate cross section AFM images of a coextruded cast multilayer BOPP film described herein, viewed at/from a plane parallel to the direction of extrusion.

FIGS. 6A and 6B illustrate cross section AFM images of a coextruded cast multilayer film described herein, viewed at/from a plane parallel to the direction of extrusion.

FIGS. 7A and 7B illustrate cross section AFM images of another coextruded cast multilayer film described herein, viewed at/from a plane parallel to the direction of extrusion.

### DETAILED DESCRIPTION

It should be noted that in the detailed descriptions that follow, identical components have the same reference numerals, regardless of whether they are shown in different embodiments of the present disclosure.

Parts are parts by weight and percents are weight percents unless otherwise indicated or apparent, such as when referencing components in a layer-like or multilayer film, in which case percents are volume percents or percent (thickness) of a multilayer structure.

As used herein, the term “aspect ratio” shall mean, the ratio of the length (L) of a domain to the lesser of its width and thickness (D), where domain is a phase of one component of the masterbatch.

As used herein, the term “barrier polymer” shall mean any polymer having a low permeability to one or more permeants of interest. In one or more embodiments, the permeant of interest is oxygen. In other embodiments, the permeant could be, for example, carbon dioxide, nitrogen, and other gases and vapors.

As used herein, the term “structural polymer” shall mean any polymer that is provided primarily for a mechanical or structural property, such as density, hardness, tear resistance, impact resistance, sealability, printability, machinability, etc. A structural polymer may have good barrier properties; however, in an embodiment having a barrier polymer with a low permeability to a particular permeant of interest, the structural polymer will have a higher permeability with regard to the permeant of interest than the barrier polymer.

As used herein, the term “copolymer” means any polymer comprising two or more different monomers, where “different” means differing by at least one atom, such as the number of carbons. The term “copolymer” specifically includes terpolymers.

As used herein, the term “ethylene vinyl alcohol” or “EVOH” includes hydrolyzed or saponified ethylene/vinyl acetate copolymers and refers to a vinyl alcohol copolymer having an ethylene comonomer, which may be obtained, for example, by the hydrolysis of an ethylene/vinyl acetate copolymer or by chemical reaction of ethylene monomers with vinyl alcohol.

As used herein, the term “masterbatch” shall mean a powdered, granulate, or pelletized composition comprising a mixture of two or more components that is used to simplify forming a product comprising the two components, rather than forming the product from the individual components. In addition, as used herein, the term encompasses both concentrated compositions, which are formulated to be mixed with one or more diluting components during the formation of the polymer product, or “fully” compounded compositions, which are not formulated to be mixed with such diluents. Unless context otherwise suggests, the phrase “MB” is used herein to denote “masterbatch”.

As used herein, the term “polymer blend” and similar terms shall mean a composition containing two or more polymers, which may or may not be miscible. Blends are not laminates, but one or more layers of a laminate may contain a blend.

As used herein, the term “polyolefin” and similar terms generally include polymers (including biopolymers) formed from a simple olefin (with the general formula CₙH₂ₙ) as a monomer, and includes both homopolymers and copolymers, (e.g., bipolymers, terpolymers, etc.), and blends thereof. In addition, they include polymers of ethylene (i.e., polyethylene), which include LDPE, LLDPE, MDPE, HDPE, copolymers of ethylene with one or more alfa-olefins, copolymers of ethylene with a vinyl ester comonomer, and blends thereof. They also include polymers of propylene (i.e., polypropylene), copolymers (e.g., bipolymers, terpolymers, etc.) of propylene with one or more alfa-olefins, and blends of different polyolefins.

As used herein, the term “functionalized polyolefin” shall mean a polyolefin provided with functionality, such as polar functionality, through copolymerization or post polymerization grafting. Such functionality is typically brought by providing chemically functional, active and/or reactive side groups to the polymer back bone, such as oxygen, halogen and/or nitrogen containing functional groups. As used herein, the term shall also mean that the functionalized polyolefin acts as a compatibilizer for the polymer blend in which it is incorporated.

As used herein, the term “compatibilizer” generally means any additive for polymer systems (e.g., polymer blends) that stabilizes the system by, for example, improving the adhesion between the system phases and/or constituent components.

In general, to create barrier performance in a film, article, etc., typically a multilayer method is employed, whereby a multilayered structure is formed via, e.g., coextrusion, and wherein at least one of the layers is a discrete layer comprised of a barrier material and at least one other layer is a discrete layer comprised of a structural material—the barrier property being provided primarily by the discrete layer of barrier material. Frequently at least one tie layer is utilized between the barrier and structural layers to provide adhesion and prevent delamination/mechanical failure.

It has been found that barrier performance approaching that of a multilayered structure (e.g., coextruded film) may be achieved in a single layer, without the need of a tie layer, by providing a pre-compounded masterbatch comprising barrier and structural polymers, and functionalized polyolefin to act as a compatibilizer, and extruding the masterbatch to form a layer having layer-like morphology. That is, assisted by the good distribution from masterbatch compounding and the shear of extrusion, separate phases form in the extruded layer that are relatively uniform and layer-like, similar to a multilayer structure fabricated by co-extrusion. Such masterbatches may be referred to hereinafter as a barrier masterbatch. The barrier masterbatch may be extruded as a monolayer or as a discrete layer in a multilayer structure.

Consequently, the present disclosure is directed to novel polymeric products and/or a method of forming polymeric products (e.g., films, sheets, and articles) comprising at least one layer that possesses layer-like morphology, using one or more barrier masterbatches. In such barrier layers having layer-like morphology, the barrier and structural phases do not exist in a matrix/domain morphology or co-continuous morphology, as described in more detail below, but instead exist as extended and elongated phases that result in a barrier performance that closely approaches the performance predicted by a series model calculation representing a multilayered structure. Such morphology affords improved barrier performance via a single layer and may avoid the use of one or more tie layers, thereby decreasing manufacturing and complexity and material costs.

In one or more exemplary embodiments herein, the barrier masterbatch includes a blend of one or more barrier polymers and one or more structural polymers, as well as a functionalized polyolefin compatibilizer. In addition, the masterbatch may optionally include other additives or fillers which may further enhance the barrier performance, such as a hydrocarbon resin, a nucleating agent, inorganic fillers (e.g., clay, calcium carbonate, p-glass, silicates, nanotubes, etc.) and/or other components.

Layer-Like Morphology

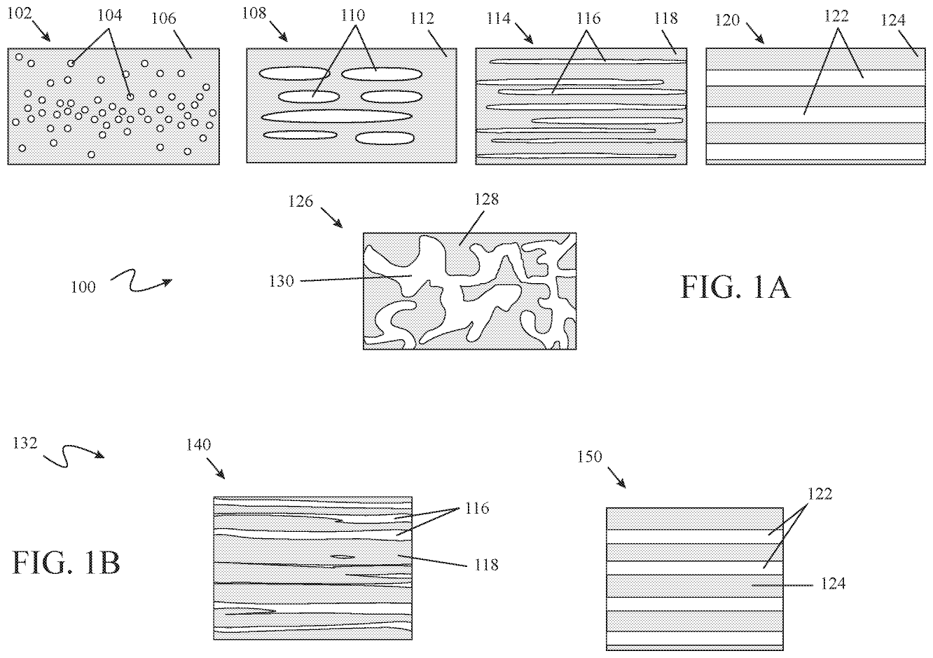

Shown in FIG. 1A is a series 100 of cross-sectional illustrations of extruded films of blended composition, having different morphologies. The cross-sections are viewed at/from a plane transverse to the direction of extrusion. Film 102 has a miscible blend morphology in which a first phase 104 that comprises relatively small and discrete domains is present with a second phase 106. Next, film 108 has a rodlike morphology in which a first phase 110 that comprises discrete domains that are relatively elongated (such as, for example, flattened rods or plank domains) is present with phase 112. Next, film 114 has a layer-like morphology in which a first phase 116 is present with a second phase 118. Next, film 120 illustrates a coextruded film having a layered/multilayered morphology, in which a first phase 122 is present as a discrete layer adjacent a second phase/discrete layer 124. Finally, film 126 illustrates a co-continuous morphology, in which a first phase 128 and a second phase 130 are present and no obvious matrix or dispersed phase can be differentiated (or each phase/both phases can be regarded as a matrix phase). Note that, although two phases are described herein for purposes of illustration, one or more embodiments may comprise three or more phases. That is, nothing discloses herein should be viewed as limiting the embodiments to two phases.

With continued reference to FIG. 1A, in general it may be seen that layer-like morphology, as illustrated in film 114, is similar to lamellae or layered morphology, as illustrated in film 120, in that it exhibits distinct or discrete phases that are fine or relatively thin, elongated in two dimensions, and alternating.

Turning to FIG. 1B, shown are cross sectional illustrations 132 of two extruded films having layer-like and layered morphologies, viewed at/from a plane parallel to the direction of extrusion. As seen in film 140—an extruded film having layer-like morphology—a first domain 116 is present with a second domain 118, and both phases are fine, elongated in two dimensions, and alternating. Similarly, as seen in film 150—a coextruded film having layered morphology—a first phase 122 is present as a discrete layer adjacent a second phase/discrete layer 124, and both phases are fine, elongated in two dimensions, and alternating.

Referring now to both FIGS. 1A and 1B, several differences between layer-like and layered morphologies may be seen. Whereas each phase of a product exhibiting layer-like morphology is finite in each dimension, the phases of a product that has layered morphology, such as film 150, have two dimensions that, if the product were extended infinitely in those dimensions, would approach infinity. This characteristic should be seen in aspect ratios of layers that are greater than (and in theory, approaching infinity) those seen in phases of layer-like morphology. Additionally, whereas each inter-phase boundary of a product having layer-like morphology, such as film 140, exhibits discontinuity and is (although elongated in two dimensions) finite, each interphase-boundary of a layered product, such as film 150, is substantially continuous and infinite. Note that other differences may exist between layered and layer-like morphologies.

Turning again to FIG. 1A, it may be seen that layer-like morphology is also different from other morphologies, such as miscible blend morphology (as illustrated by film 102) and rodlike or plank morphology, as illustrated by film 108. In general, it may be seen that products having such other morphologies do not exhibit the discrete, relatively fine or thin, alternating phases of products having layer-like morphology.

The structural polymer(s) in the barrier masterbatch may be one or more polyolefins, one or more ionomers, polycarbonates, polyesters (including polylactic acids and polyhydroxyalkanoate (PHA)) and/or styrenic polymers and/or styrenic copolymers, including any such biopolymers, bio-based polymers biodegradable or compostable polymers. Polyolefins have been found to be particularly suitable for use as the structural polymer(s). Suitable polyolefins may generally be any olefin homopolymer or any copolymer of an olefin and one or more comonomers. The polyolefins may be atactic, syndiotactic or isotactic. The olefin may be a mono olefin or a diolefin. Mono olefins include ethylene, propylene, 1-butene, 1-pentene, 1-hexene, 4-methyl-1-pentene and 1-octene, as well as cycloolefins, such as cyclopentene, cyclohexene, cyclooctene and norbornene. Diolefins include butadiene (such as 1,3-butadiene), 1,2-propadiene, 2-methyl-1,3-butadiene, 1,5-cyclooctadiene, norbornadiene, dicyclopentadiene, 1,3-heptadiene, 2,3-dimethylbutadiene, 2-ethyl-1,3-pentadiene, 1,3-hexadiene and 2,4-hexadiene. Most suitably, the olefin is an alpha-olefin. The comonomer if present is different from the olefin and is chosen such that it is suitable for copolymerization with the olefin. The comonomer may also be an olefin as set forth above. Comonomers may include ethylene, propylene, 1-butene, 4-methyl-1-pentene, 1-hexene, 1-octene, 1-decene, 1-dodecene, 1-tetradecene, 1-hexadecene and 1-octadecene. Further examples of suitable comonomers may include vinyl esters, vinyl acetates, vinyl acrylates, and acid copolymer monomers.

Non-limiting examples of polyolefins that may be used as the structural polymer(s) in the barrier masterbatch include polymers of ethylene, such as ultralow density polyethylene (ULDPE), low density polyethylene (LDPE), linear low density polyethylene (LLDPE), medium density polyethylene (MDPE), high density polyethylene (HDPE), high melt strength high density polyethylene (HMS-HDPE), ultrahigh density polyethylene (UHDPE), and combinations thereof. Also suitable for use are copolymers of ethylene with one or more alpha-olefins and copolymers of ethylene with a vinyl ester or acid copolymers. Blends of the foregoing ethylene polymers and copolymers are also suitable. Examples may include ethylene vinyl acetate (EVA), ethylene butyl acrylate (EBA), ethyl methyl acrylate (EMA), and ethylene/acrylic acid (EAA) copolymers, ethylene/methacrylic acid (EMAA) copolymers, such as ethylene, methyl acrylate and glycidyl methacrylate, etc.

Further examples of polyolefins that may be used as structural polymer(s), such as in the barrier masterbatch, include polymers of propylene, such as low density polypropylene, high density polypropylene, high melt strength polypropylene, homopolymer polypropylene, mini-random copolymer polypropylene, random copolymer polypropylene, impact polypropylene (HIPP), polypropylene (PP), including both syndiotactic polypropylene (sPP) and isotactic polypropylene (iPP), and combinations thereof. Also suitable for use are copolymers of propylene with one or more alpha-olefins. Blends of the foregoing propylene polymers copolymers are also suitable.

LLDPE, LDPE, MDPE, HDPE, and PP (homopolymer and copolymers) have been found or are considered to be especially suitable for use as the structural polymer(s) in the barrier masterbatch. Generally, these polyolefin(s) may be formed in slurry, solution or gas-phase processes, using Ziegler-Natta catalysts or single-site catalysts (including metallocene catalysts) or a combination of such catalysts.

LLDPE is a substantially linear polymer with no long chain branching and typically has a density in a range of about 0.915-0.930 g/cm³. LLDPE is commonly made by copolymerization of ethylene with short-chain alpha-olefins (for example, 1-butene, 1-hexene and 1-octene). An example of commercially available LLDPE, which may be used in the barrier masterbatch, includes LLDPE LL 3001, which is available from ExxonMobil Chemical. LLDPE LL 3001 is a hexene copolymer LLDPE having a density of 0.917 g/cm³.

HDPE is also a substantially linear polymer and has little branching, which gives it a high strength-to-density ratio. Typically, HDPE has a density in a range from 0.930 to 0.970 g/cm³. An example of commercially available HDPE, which may be used in the barrier masterbatch, includes Alathon M6210, which is available from LyondellBasell. Alathon M6210 is a medium molecular weight HDPE having a density of 0.958 g/cm³. Another example of a commercially available HDPE, which may be used in the barrier masterbatch, includes Chevron Marlex® 9656 HDPE and Surpass® 167AB HDPE which is available from Nova Chemicals. Marlex 9656 and Surpass 167AB are HDPE resins having densities of 0.956 and 0.967 g/cm³, respectively.

PP homopolymer is a homogeneous polymer and has a density in a range from 0.895 and 0.920 g/cm³. An example of commercially available PP homopolymer, which may be used in the barrier masterbatch, includes PPH 3371, which is an iPP available from Total Petrochemicals & Refining USA. PPH 3371 has a density of 0.905 g/cm³.

The barrier polymer(s) in the barrier masterbatch may include one or more EVOH copolymers, one or more polyvinyl alcohol (PVOH), polyamides, polyvinylidene chloride (PVDC), fluorpolymers like polytetrafluoroethylene (PTFE) or polyvinylidene fluoride (PVDF), cylic olefin copolymers (COC), one or more nitrile polymers, like polyacrylonitrile (PAN), and/or liquid crystal polymers (LCP).

EVOH is a formal copolymer of ethylene and vinyl alcohol and is formed by polymerizing ethylene and vinyl acetate to form ethylene vinyl acetate (EVA), which is then hydrolyzed. Typically EVOH with lower ethylene content has higher barrier properties. A suitable EVOH for use in the barrier masterbatch has an ethylene content of at least 24 mole %, more suitably from 27 mole % to about 55 mole % ethylene, more suitably from 27 mole % to about 44 mole %.

Examples of commercially available EVOH include Eval E171 and F171, which are available from Kuraray Co., Ltd. Eval E171 has 44 mole % ethylene, a density of 1.14 g/cm³ and a melt temperature of 165° C. Eval F171 has 32 mole % ethylene, a density of 1.19 g/cm³, and a melt temperature of 183° C. Eval F171 has 27 mole % ethylene, a density of 1.20 g/cm³, and a melt temperature of 191° C. Other examples may include Soarnol EVOH from Nippon Gohsei and Evasin EVOH from Changchun petrochemical.

Polyamides that may be used as barrier polymer(s) may be homopolymers and/or copolymers and may be aliphatic and/or aliphatic/aromatic. Exemplary and useful polyamides include poly(6-aminohexanoic acid) (nylon 6, also known as poly(caprolactam), poly(hexamethylene adipamide)(nylon 6,6) and polyamides produced through polycondensation of meta-xylylene diamine (MXDA) with adipic acid, such as poly(m-xylylene adipamide) (MXD6).

Nitrile polymers that may be used as barrier polymer(s) include acrylonitrile-methyl acrylate copolymers, acrylonitrile-styrene copolymers, acrylonitrile-indene copolymers; and homo and copolymers of methacrylonitrile. Commercially available nitrile polymers include the BAREX line of polymers available from Ineos Olefins & Polymers USA, which are acrylonitrile-methyl acrylate copolymers.

Generally, the barrier masterbatch comprises (in weight percent) from about 30% to about 70% structural polymer(s), from about 30% to about 70% barrier polymer(s), from about 0.2 to about 20% functionalized polyolefin compatibilizer, from about 0 to about 20% hydrocarbon resin and from about 0 to about 0.4% nucleating agent. In one or more embodiments, the barrier masterbatch may also include from 0% to about 40% inorganic fillers. More suitably, the barrier masterbatch comprises (in weight percent) from about 30% to about 70% structural polymer(s), from about 30% to about 70% barrier polymer(s), from about 3 to about 10% functionalized polyolefin compatibilizer, from about 0 to about 13% hydrocarbon resin and from about 0 to about 0.2% nucleating agent. Also more suitably, the barrier masterbatch comprises (in weight percent) from about 35% to about 65% structural polymer(s), from about 35% to about 65% barrier polymer(s), and from 5% to 10% functionalized polyolefin compatibilizer.

In a first embodiment, the barrier masterbatch comprises from about 45% to about 55% structural polymer, from about 45% to about 55% barrier polymer and from about 3% to about 10% functionalized polyolefin compatibilizer, with a particularly suitable composition comprising about 45% to about 55% structural polymer, from about 45% to about 55% barrier polymer and from 5% to 10% functionalized polyolefin compatibilizer. Even more suitably, the first embodiment comprises about 47.5% HDPE, about 47.5% EVOH and about 5% functionalized polyolefin compatibilizer.

In a second embodiment, the barrier masterbatch comprises from about 35% to about 45% structural polymer, from about 45% to about 65% barrier polymer and from about 3% to about 10% functionalized polyolefin compatibilizer, with one particularly suitable barrier masterbatch comprising from about 35% to about 45% structural polymer, from about 45% to about 65% barrier polymer and from 5% to 10% functionalized polyolefin compatibilizer. Even more suitably, the second embodiment comprises about 40% PP homopolymer, about 55% EVOH and about 5% functionalized polyolefin compatibilizer.

As described above, in addition to structural polymer(s) and barrier polymer(s), the first and second embodiments include a functionalized polyolefin compatibilizer, which comprises from about 0.2 to about 20 weight percent, more suitably from about 3 to about 10 weight percent of the barrier masterbatch, and even more suitably from 5 to 10 weight percent of the barrier masterbatch.

The functionalized polyolefin compatibilizer may be a copolymer of ethylene and/or propylene and one or more unsaturated polar monomers, which may include: C₁ to C₈ alkyl (meth)acrylates, such as methyl, ethyl, propyl, butyl, 2-ethylhexyl, isobutyl and cyclohexyl (meth)acrylates; unsaturated carboxylic acids, their salts and their anhydrides, such as acrylic acid, methacrylic acid, maleic anhydride, itaconic anhydride and citraconic anhydride; unsaturated epoxides, such as aliphatic glycidyl esters and ethers such as allyl glycidyl ether, vinyl glycidyl ether, glycidyl maleate and glycidyl itaconate, glycidyl acrylate and glycidyl methacrylate, and also alicyclic glycidyl esters and ethers; and vinyl esters of saturated carboxylic acids, such as vinyl acetate, vinyl propionate and vinyl butyrate. Examples of functionalized polyolefin compatibilizers formed by copolymerization include ethylene/acrylic acid (“EAA”) copolymers and ethylene/methacrylic acid (“EMAA”) copolymers. Commercially available functionalized polyolefins formed by copolymerization include: PRIMACOR resins available from the Dow Chemical Company, which are EAA copolymers; NUCREL resins available from E. I. du Pont de Nemours and Company, which are EMAA resins; and LOTADER 8900 available from the Arkema Group, which is a terpolymer of ethylene, methyl acrylate and glycidyl methacrylate.

The functionalized polyolefin compatibilizer may also be an acid or acid anhydride modified polyolefin obtained by modifying a polyolefin, such as a polyethylene or a polypropylene, with an unsaturated carboxylic acid, such as acrylic acid, methacrylic acid, maleic acid, maleic anhydride, fumaric acid or itaconic acid. Combinations of different types of chemically modified polyolefins may also be used. Particularly suitable is a polyethylene and/or a polypropylene that is/are graft-modified with a maleic acid or a maleic anhydride. An example of a commercially available acid anhydride modified polyolefin includes Orevac 18360, which is available from the Arkema Group. Orevac 18360 is a maleic anhydride modified LLDPE having a density of 0.914 g/cm3 and a melt temperature of 120° C. Another example of a commercially available acid modified polyolefin includes Orevac CA 100, which is available from the Arkema Group. Orevac CA 100 is a maleic anhydride modified polypropylene having a density of 0.905 g/cm³ and a melt temperature of 167° C. Still another example of a commercially available acid modified polyolefin includes Exxelor PO 1015, which is available from ExxonMobil Chemical. Exxelor PO 1015 is a maleic anhydride functionalized polypropylene copolymer.

In one non-limiting example of the first embodiment disclosed herein, the barrier masterbatch may include HDPE, EVOH and a maleic anhydride modified polyethylene. More specifically, the barrier masterbatch may comprise (in weight percent) from about 45% to about 55% HDPE, from about 45% to about 55% EVOH and from about 3% to about 10% maleic anhydride modified polyethylene. Even more specifically, in one or more embodiments herein, the barrier masterbatch may comprise from about 45% to about 55% HDPE, from about 45% to about 55% EVOH and from 5% to 10% maleic anhydride modified polyethylene. with a particularly suitable barrier masterbatch comprising about 47.5% HDPE, about 47.5% EVOH and about 5% maleic anhydride modified polyethylene. The latter has been found particularly suitable for forming blown film for use in a barrier application.

In one non-limiting example of the second embodiment disclosed herein, the barrier masterbatch may include PP homopolymer, EVOH and a maleic anhydride modified polypropylene. More specifically, the barrier masterbatch may comprise (in weight percent) from about 35% to about 45% PP homopolymer, from about 45% to about 65% EVOH and from about 3% to about 10% maleic anhydride modified polypropylene. Even more specifically, in one or more embodiments herein, the barrier masterbatch may comprise from about 35% to about 45% PP homopolymer, from about 45% to about 65% EVOH and from 5% to 10% maleic anhydride modified polypropylene, with one particularly suitable barrier masterbatch comprising about 40% PP homopolymer, about 55% EVOH and about 5% maleic anhydride modified polypropylene.

Any of the first and second embodiments of the barrier masterbatch may be modified to further include (in weight percent) from about 2% to about 20%, more suitably from 3% to about 13% of a hydrocarbon resin and/or from about 0.01% to about 0.4%, more suitably from about 0.04% to about 0.2% of a nucleating agent.

The hydrocarbon resin may include petroleum resins, styrene resins, terpene resins, cyclopentadiene resins, saturated alicylic resins and mixtures of the foregoing. The hydrocarbon resin be a thermally polymerized dicyclopentadiene resin that is hydrogenated to be transparent. Such a hydrocarbon resin may be formed by heating a reaction material including a dicyclopentadiene monomer, under autogenous pressure, at an elevated temperature, in the presence of one or more strong acids, alone or in combination with olefinic modifiers. Alternately, the hydrocarbon resin may be a catalytically polymerized resin made from a monomeric mixture (such as one comprising 1,3-pentadiene, cyclododecatriene and one or more monoolefins) using a Friedel-Crafts catalyst, such as boron, boron trifluoride or aluminum chloride. The hydrocarbon resin may also be a cycloaliphatic resin or contain appropriate levels of aromatics. Examples of commercially available hydrocarbon resins include OPPERA modifiers, which are available from ExxonMobil Chemical, such as OPPERA 383 and OPPERA PR 100.

The nucleating agent may be talc, a glycerol alkoxide salt, a hexahydrophthalic acid salt, a sorbitol acetal, a phosphate ester salt and mixtures thereof.

The glycerol alkoxide salt may be selected from the group consisting of zinc, magnesium, and calcium glycerolates and mixtures thereof. A particularly suitable glycerol alkoxide salt is a zinc glycerolate. Zinc glycerolate has been found to be particularly suitable as a nucleating agent for polypropylene. Zinc glycerolate is available from BASF as Irgostab 287.

The hexahydrophthalic acid salt may be selected from the group consisting of zinc, magnesium, and calcium hexahydrophthalates and mixtures thereof. A particularly suitable hexahydrophthalic acid salt is calcium hexahydrophthalate. Calcium hexahydrophthalate has been found suitable as a nucleating agent for both polyethylene and polypropylene. Calcium hexahydrophthalate is available from Milliken Company as Hyperform HPN-20E.

Examples of a sorbitol acetal that may be used as a nucleating agent include 1,3:2,4-Bis(3,4-dimethylobenzylideno) sorbitol, which is commercially available from Milliken Chemical as Millad 3988, and bis(4-propylbenzylidene) propyl sorbitol, which is commercially available from Milliken Chemical as Millad NX 8000. Both Millad 3988 and Millad NX 800 are especially suitable for use as nucleating agents for PP.

A phosphate ester salt that may be used as a nucleating agent is 2,2′-Methylene-bis(2,4-di-tert-butylphenyl)phosphate lithium salt, which is commercially available from Adeka Corporation as NA-71. Adeka Corporation's NA-11 and NA-21 may also be suitable.

The embodiments of the barrier masterbatch described above may be produced in a continuous operation, a batch operation, or in a combined batch/continuous operation.

In a continuous operation, the structural polymer, barrier polymer, and any other components (such as a chemically modified polyolefin) may be fed into a continuous mixer, single or twin screw extruder via volumetric or gravimetric feeders. The extruder is heated to a temperature that is sufficient to melt the polymers, such as between 200 C and 250 C. The components are fed into the extruder and mixed/blended together in a molten state. Extruder speeds can range from about 50 to about 1200 revolutions per minute (rpm) and more typically from about 300 to about 700 rpm. Gases from the extruder may be withdrawn by a vacuum pump. The output from the extruder is usually cooled (such as in a water bath or underwater granulator) and pelletized to form the barrier masterbatch.

In a batch operation, the structural polymer(s), barrier polymer(s), and any other components (such as a functionalized polyolefin compatibilizer) are added to a mixing device, such as a Banbury mixer, and are heated to a temperature that is sufficient to melt the polymers, such as between 200° C. and 250° C. The mixing speeds typically range from 300 to 700 rpm. The output from the mixer is cooled and pelletized to form the barrier masterbatch.

In a combined batch/continuous operation, the structural polymer(s), barrier polymer(s), and any other components (such as a functionalized polyolefin compatibilizer) may be mixed together in a batch pre-mix operation and then fed into a single or twin screw extruder via a volumetric or gravimetric feeder. The mixing may be dry or may be performed in a heater-cooler mixing apparatus, wherein the components are first mixed at an elevated temperature in an upstream mixer and then mixed in a downstream mixer, where some of the heat is allowed to dissipate.

It should be appreciated that the barrier masterbatch may be produced using equipment and operations other than those described above. For example, the barrier masterbatch may be produced using a continuous mixer or a kneader, such as a BUSS kneader.

In methods of the present disclosure, the aforementioned masterbatches may be processed to produce novel polymeric products having layer-like morphology and exhibiting improved properties, such as good barrier properties. Polymeric products described in the embodiments herein may include single (i.e., monolayer) or multilayered films, sheets, and articles (e.g., packages, pouches, pieces, tubes, pipes, containers, etc). Such polymeric products may be formed by generally any suitable process, including (for example): cast and blown film processes; oriented and biaxially oriented film processes; double-bubble and triple-bubble film processes, extrusion and extrusion-related processes, such as, e.g., sheet extrusion (which may be followed by thermoforming), extruded tapes, extrusion blow molding; pipe extrusion, extrusion coating, etc.; molding processes, including blow molding and injection molding; and thermoforming processes.

Without wishing to be bound by theory, it is believed that the selection of polymer components (structural, barrier, and/or functionalized compatibilizer) and the relative amounts of such components provides an appropriate balance of immiscibility and adhesion, which help the formation of phase separation, but keep the integration of the blends at the same time. The functionalized compatibilizer component helps act like a tensid molecule/compatibilizer to control the surface energy. Also without wishing to be bound by theory, it is believed that the shear stresses imparted to the polymeric system by the product-formation processes, such as those described above, cause the product to achieve layer-like morphology. Processing conditions of product formation, as well as those of masterbatch processing, may also factor.

In one or more exemplary embodiments described herein, packaging material may be produced from the barrier masterbatch. The packaging material may comprise a monolayer or multilayer film, which is cast or blown. In a monolayer embodiment, pellets of the barrier masterbatch are loaded into a single or twin screw extruder, where they are heated to an elevated temperature between 200° C. and 250° C., thereby causing them to melt and flow. The rotating screw conveys the melted barrier masterbatch and pushes it through a narrow die opening, which is typically flat for a cast film and annular for a blown film.

If a cast film is being produced, extrudate (e.g., in the form of, e.g., a thin flat curtain) of the molten barrier masterbatch exits the die opening and moves downward through gravity and the assistance of an air knife or vacuum box to tangentially contact a surface of a rotating cooling roller, which is chrome plated and chilled with water. The extrudate typically has a thickness from about 20 microns to about 5100 microns. The cooling roller cools and solidifies the extrudate, sometimes imparting orientation to the resulting film. The film may then pass over a cleaning roller and a second cooling roller. Thereafter, edges of the film are slit off and the film is wound up on one or more rolls. The thickness of the film may be controlled using movable die lip sections that can change the opening thickness across the width of the die opening. The die lip sections may be automatically moved in response to measurements of the film thickness taken downstream. The thickness of the cast film formed from the barrier masterbatch is typically in a range of from about 10 microns to about 250 microns.

If a blown film is being produced, an inflated, long circular bubble of the molten barrier masterbatch is pulled upwards from the annular die opening. As the bubble is pulled upward, the diameter of the bubble increases due to the air pressure inside. This pulling and expanding of the bubble causes the melt to thin in both the machine direction and the cross machine direction (transverse direction), thereby causing some orientation effects in both directions. Chilled air is blown against the exterior of the bubble and may also be directed inside the bubble through channels in the die. The chilled air cools the bubble, which continues to be pulled upward through a support tower. The bubble is progressively collapsed between sets of rollers or frames and is fed into a nip formed from two co-rotating rollers. The nip seals the bubble to prevent it from deflating and is responsible for pulling the bubble upward from the dies. After passing through the nip, the collapsed bubble may be wound on to a roll as a tube of film, or the folded over edges may be removed to form two separate sheets of film, which are then wound onto two separate rolls. The thickness of blown film is more difficult to control than the thickness of cast film. Nonetheless, the thickness of blown film may be controlled to some extent by changing the relative positions of movable concentric die lips and/or changing the orientation of the collapsing rollers/frames in response to film thickness measurements. The thickness of the blown film formed from the barrier masterbatch is in a range of from about 12 microns to about 250 microns.

Regardless of how the film is formed, the film may subsequently be oriented in one or more directions to further improve the film's properties, including its layer-like morphology. For example, the film may be immediately reheated to a temperature below the melting point of one or more polymers in the film, but high enough to enable the composition to be drawn and/or stretched to achieve a desired orientation. The film may be oriented in only one direction (uniaxial), such as in the machine direction (MDO), or in the cross direction (TDO). Alternately, the film may be oriented in both the machine direction and the cross direction, so as to be biaxially oriented (BO). Such biaxial orientation may be performed sequentially or concurrently/simultaneously. In the case of sequential orientation, the “softened” film is drawn by rolls rotating at different speeds or rates of rotation such that the film is stretched in the machine direction. Subsequently, the film may be clamped at its lateral edges by chain clips and conveyed into one or more ovens. While being heated in the oven(s), the chain clips are moved apart laterally to stretch the film in the cross direction. Generally any other suitable manner of orienting films may be utilized in the embodiments described herein, such as for example tenter frame techniques and double or triple-bubble blown processes.

In a multilayer embodiment, a plurality of extruders are used, together with a feedblock, which is connected between the extruders and a die. Pellets of the barrier masterbatch are loaded into one of the extruders, where they are heated to an elevated temperature, thereby causing them to melt and flow. One or more other masterbatches or polymers, polymer compounds or polymer blends are added to the other extruder(s), where they are heated to an elevated temperature, thereby causing them to melt and flow. The melts from the extruders are fed to the feedblock where they are combined and then passed through the die, which spreads the composite layers across the desired width. After the die, the multi-layer extrudate is formed into either a cast or blown multi-layer film and may be oriented in one or more directions by generally any suitable means (e.g., double or triple-bubble processes). In this way, the barrier masterbatch is coextruded with one or more other polymer compositions to form a multi-layer film.

Generally any suitable polymer composition may be utilized in the other layer(s) to form multilayer polymeric products. For example, other polymer compositions that may be used with the barrier masterbatch to form coextruded multi-layer packaging films include, but are not limited to: LLDPE, LDPE, MDPE, HDPE, polypropylene (homopolymer and copolymers) polyamides, polyesters, polystyrene, polylactic acid, and blends of the foregoing. Different embodiments of the barrier masterbatch may also be coextruded so as to form multilayer films, wherein each layer is comprised of blended polymers.

As mentioned, the polymeric products (e.g., film, sheet or article, such as a package or bottle) disclosed herein exhibit layer-like morphology, as described above in relation to FIGS. 1A & 1B. Without wishing to be bound by theory, it is believed that the discrete, alternating and two-dimensionally elongated (layer-like) domains in a product having layer-like morphology improve such physical properties as barrier properties by increasing the tortuosity of any path a permeant must cross in order to permeate the system. In fact, one or more physical properties (e.g., permeability) may be useful to determine whether a product has layer-like morphology, in the following manner. By plotting measured values of the selected physical parameter (e.g., permeability) for a product and comparing them with actual or modeled values for miscible blend and layered system controls, one may measure the relative proximity of the parameter to either control and determine if it is sufficiently close to the layered system control to be considered layer-like. The following Example 1 demonstrates this principle.

### Example 1

Monolayer films are formed using two-component masterbatches (referenced hereinafter by their MB #), along with film control samples, having the following compositions:

| MB# | Component | Identity | Wt % |
|---|---|---|---|
| MB1 | LLDPE | LL 3001 from ExxonMobil Chemical | 50 |
| | EVOH | Eval E171 Kuraray Co., Ltd | 50 |
| MB2 | HDPE | Surpass 167AB from Nova Chemicals | 50 |
| | EVOH | Eval E171 from Kuraray Co., Ltd | 50 |
| control | LLDPE | LL 3001 from ExxonMobil Chemical | 100 |
| control | HDPE | Surpass 167AB from Nova Chemicals | 100 |
| control | EVOH | Eval E171 Kuraray Co., Ltd | 100 |

For each masterbatch, a blended mixture of the components is formed in a heated extruder and then pelletized. Subsequently, the formed masterbatch is subjected to a melt extrusion process in a single screw extruder having a 1 inch screw diameter and an aspect ratio of 25. The extruder is connected to a 14-inch wide exit-die by a feedblock

The first and second masterbatches are extruded at a temperature of approximately 250° C. to form 25 μm thick cast film. Film formed using MB1 is hereinafter referenced as Film 1, while the film formed using MB2 is referenced as Film 2. LLDPE, HDPE, and EVOH control films are similarly cast extruded.

Oxygen permeability, measured as oxygen transfer rate, of the films is measured using a Mocon® Ox-Tran® 2/21L unit at 23° C. with 0% relative humidity. The results are as follows:

| | P(O₂) | Series Model P(O₂) | Blend Model P(O₂) |
|---|---|---|---|
| | cc · mil/ | cc · mil/ | cc · mil/ |
| Film | 100 in² · day · atm | 100 in² · day · atm | 100 in² · day · atm |
| LLDPE cast | 617.9 | / | / |
| control | | | |
| HDPE cast | 67.5 | / | / |
| control | | | |
| EVOH cast | 0.243 | / | / |
| control | | | |
| Film 1 (MB1) | 0.61 | 0.54 | 18.7 |
| Film 2 (MB2) | 0.61 | 0.54 | 18.7 |

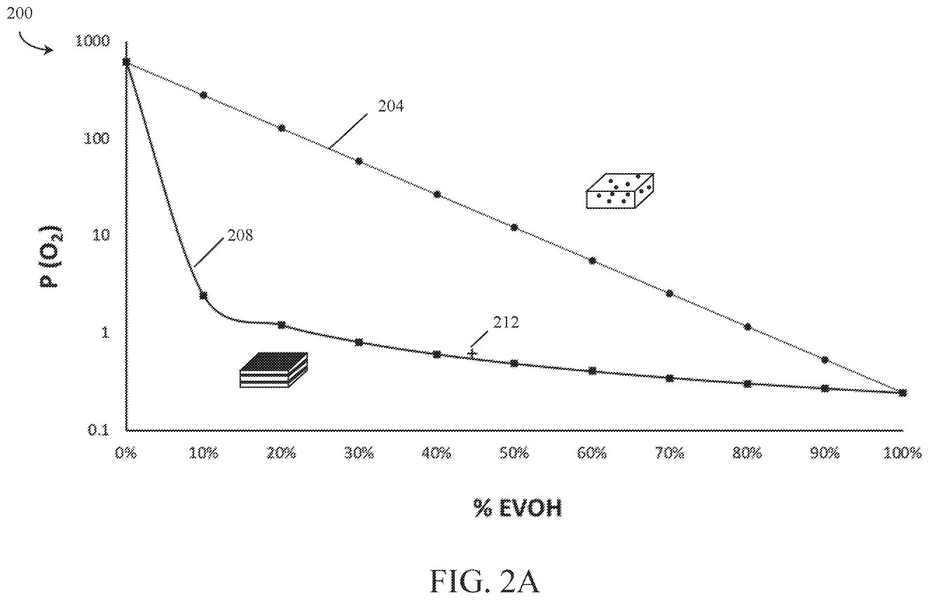

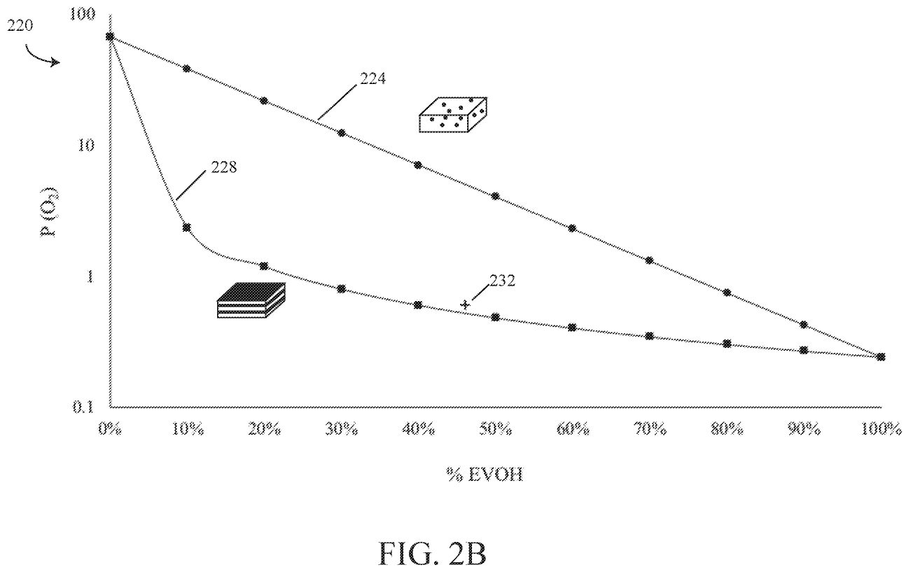

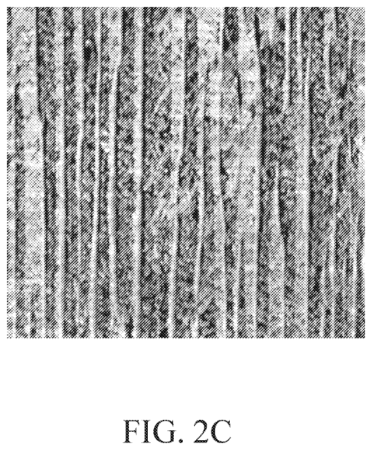

With reference to FIG. 2A, a graph 200 is shown containing plots 204 and 208 of two permeability models—a miscible blend model (see line 204) and series/layered model (see curve 208)—for a two-component (LLDPE/EVOH) ˜1 mil. film. The y-coordinate axis has a logarithmic scale and represents oxygen permeability values (cc·mil)/(100 in²·day·atm) of the film, while the x-coordinate axis has a linear scale and represents vol. % of EVOH of the film.

With continued reference to FIG. 2A, both models (plotted at 204 & 208) assume that each component's permeability does not change in the multi-component system. Miscible blend model and series model are provided by the following equations, respectively:

Ln P_{film}=∅₁ Ln P₁+∅₂ Ln P₂ (1);

P_{film}=1/(∅₁/P₁+∅₂/P₂) (2);

where P1 and P2 are the measured oxygen permeabilities of component controls (e.g., LLDPE and EVOH control films, respectively), and ∅1 and ∅2 are the volume fractions of the components in the system (namely, 44.6 vol % (50 wt %) in this example) of LLDPE and EVOH. For the LLDPE control film, permeability is measured to be 617.9 (cc·mil)/(100 in²·day·atm), i.e. the value at the left hand border of the graph having 0 vol. % EVOH. For the EVOH control film, permeability is measured to be 0.243 (cc·mil)/(100 in²·day·atm), as indicated in the figure at the right hand side border of the graph where the vol. % EVOH is 100%.

Reviewing FIG. 2A, it may be seen that miscible blend model 204 indicates a system permeability for miscible blend morphology that decreases logarithmically with increased volumetric fraction of the barrier polymer (EVOH), while series model 208 indicates a system permeability for multilayer structures (typically fabricated by co-extrusion) that initially decreases faster than logarithmically with an increasing fraction of the barrier polymer (EVOH). In other words, an LLDPE/EVOH product having layered morphology, as modeled by series model 208, has a much better O₂ barrier property (i.e. a lower permeability) than one with miscible blend morphology.

With continued reference to FIG. 2A, by plotting one or more data points for measured values of a product's permeability, one may obtain an indication of the morphology of the product. For example, plotting the measured permeability value for Film 1 of 0.61 (cc·mil)/(100 in2·day·atm) against the corresponding series model, shown by data point 212 in FIG. 2A, indicates a layer-like morphology, since the measured value is in line with the series model. More generally, in one or more embodiments described herein, a layer-like morphology is indicated if the measured permeability value of a product (e.g. a film) is closer to the permeability value calculated for a series model than a miscible blend model. As used herein, a measured permeability value of a product is “closer to” a series model if the measured permeability value is below the arithmetic average of the two permeabilities calculated according to the series and miscible blend models for the same volume fraction of barrier polymer.

Turning now to FIG. 2B, a measured value for Film 2 is similarly plotted against a miscible blend model (see line 224) and series/layered model (see curve 228) that are plotted for the relevant components (HDPE, EVOH). The model plots are generated using equations (1) and (2), above, and a measured permeability value for the HDPE cast control film is 67.5 cc·mil/100 in²·day·atm., i.e. the value at the left hand border of the graph having 0 vol. % EVOH. The measured permeability for the EVOH control film is discussed above and indicated in FIG. 2B at the right hand side border of the graph where the vol. % EVOH is 100%. Plotting the measured permeability value for Film 2 of 0.61 (cc·mil)/(100 in2·day·atm) against the corresponding series model, shown by data point 232 in FIG. 2B, indicates a layer-like morphology, since the measured value is in line with the series model.

The morphology of these films is also investigated using atomic force microscopy (AFM). An AFM phase image of Film 1 is taken from the extruded direction (i.e., from a plane parallel to the extruded direction) and illustrated in FIG. 2C (image scale is 10 μm). As shown in FIG. 2C, Film 1 exhibits layer-like morphology, as seen in relation to the alternating phases of the barrier and structural polymers (EVOH and LLDPE, respectively), illustrated by having different grayscale values, that are elongated, discrete, layer-like domains.

Qualitative observations from producing the 2-component films of Example 1, as well as attempting to use these 2-component barrier masterbatches to produce film via a blown film process, indicate that processability may not be sufficient for use in many commercial applications, due to a degree of polymer incompatibility. In addition, qualitative observation from attempting to produce film via cast or blown film processes using a 2-component barrier masterbatch in which the structural polymer was iPP homopolymer and the barrier polymer was EVOH, also indicates that processability is not sufficient for commercial application. Also, processability concerns are expected to increase when using barrier polymers of increasing polarity. Accordingly, in order to improve processability overall, across a spectrum of barrier and structural polymer component blends, compatibilizer is utilized in the barrier masterbatches of the embodiments disclosed herein, as more fully described below. Surprisingly, addition of compatibilizer did not disrupt the layer-like morphology of the film, as explained more fully below.

In the following examples, monolayer and multilayer films were formed using a few such barrier masterbatches.

### Example 2

Monolayer films are formed using two exemplary embodiments of barrier masterbatches disclosed herein (referenced hereinafter by their MB #), along with film control samples, having the following compositions:

| MB# | Component | Identity | Wt % |
|---|---|---|---|
| MB3 | HDPE | Alathon M6210, from Lyondell Basell | 47.5 |
| | EVOH | Eval E171 from Kuraray Co., Ltd | 47.5 |
| | Compatibilizer | Orevac 18360 from Arkema Group | 5 |
| | (maleic acid | | |
| | modified LLDPE) | | |
| MB4 | iPP homopolymer | PPH 3371 from Total Petrochemicals | 40 |
| | EVOH | Eval E171 from Kuraray Co., Ltd | 55 |
| | Compatibilizer | Orevac CA 100 from Arkema Group | 5 |
| | (maleic acid | | |
| | modified PP) | | |
| control | iPP homopoymer | PPH 3371 from Total Petrochemicals | 100 |
| control | HDPE | Surpass 167AB from Nova Chemicals | 100 |
| control | EVOH | Eval E171 Kuraray Co., Ltd | 100 |

For each, the components are blended/mixed in a compounding extruder and pelletized.

The third masterbatch (MB3) is used to form a blown film using a Collin 3-layer blown film line at 200° C. to 250° C. When producing a monolayer sample, as in this example, only one extruder was used. Film formed using MB3 is hereinafter referenced as Film 3.

The fourth masterbatch (MB4) is extruded at a temperature of 200° C. to 250° C. to form 25 μm thick cast film. Film formed using MB4 is hereinafter referenced as Film 4.

Oxygen permeability of the films is tested at 23° C. and 0% relative humidity. In addition, the water vapor permeability (WVTR) of the films is measured as a transfer rate at 37.8° C. and 100% relative humidity using a Mocon® Permetran® 3/34G unit, and the results are shown below.

| | P(O₂) | P (H₂O) |
|---|---|---|
| FILM | cc · mil/100 in² · day · atm | g · mil/100 in² · day · atm |
| HDPE control | 116.4 | |
| (blown) | | |
| PP control (cast) | 183.1 | |
| EVOH control | 0.15 | |
| (blown) | | |
| Film 3 (MB3) | 0.56 | 0.41 |
| (blown) | | |
| Film 4 (MB4) | 0.92 | 1.2 |
| (cast) | | |

The measured permeability value for the blown HDPE control film (in relation to Film 3) is 116.4 cc·mil/100 in²·day·atm. The measured permeability value for the cast PP control film (in relation to Film 4) is 183.1 cc·mil/100 in²·day·atm. The cast EVOH control film permeability is 0.243 cc·mil/100 in²·day·atm, as discussed above in relation to Example 1. In addition a blown EVOH control film is measured to be 0.150 cc·mil/100 in²·day·atm.

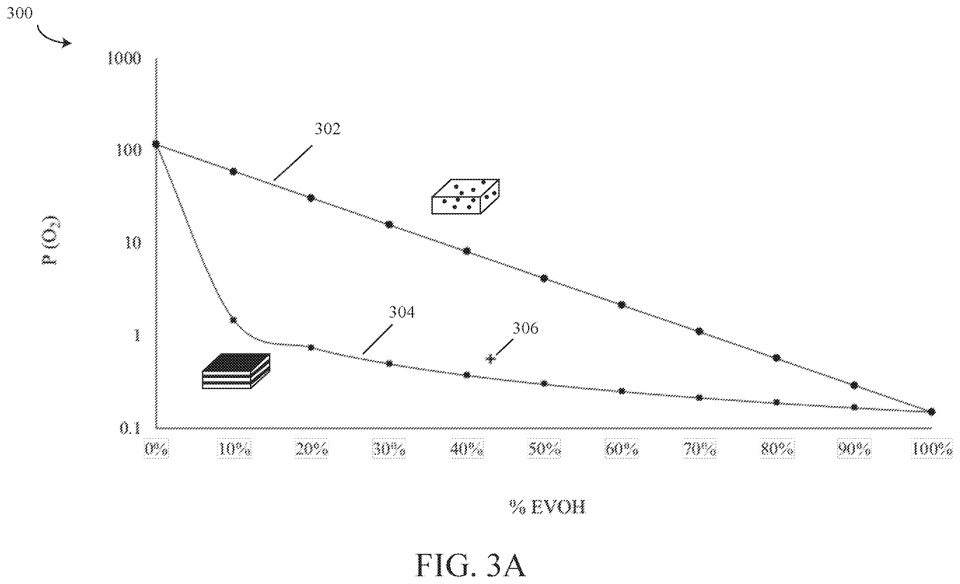

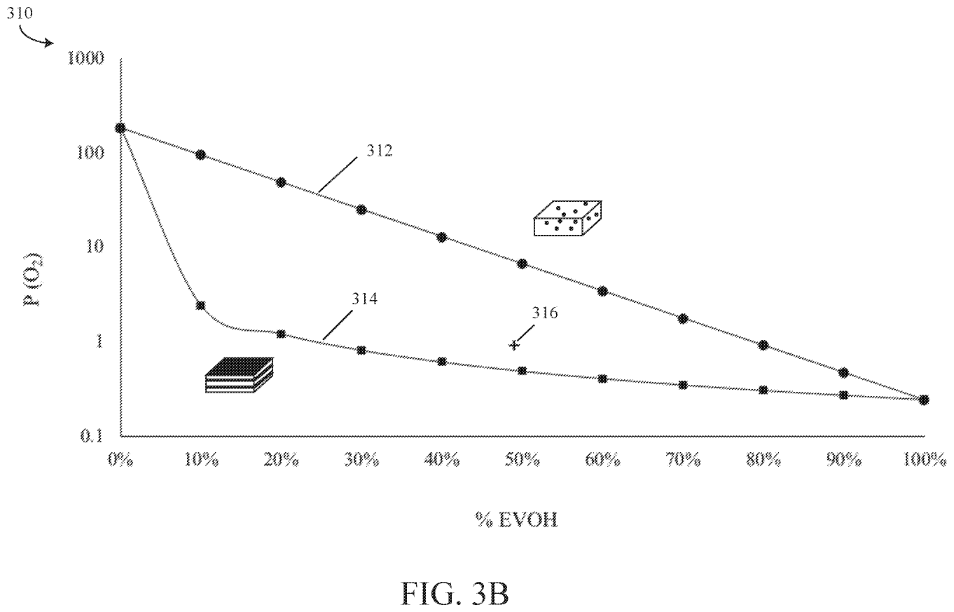

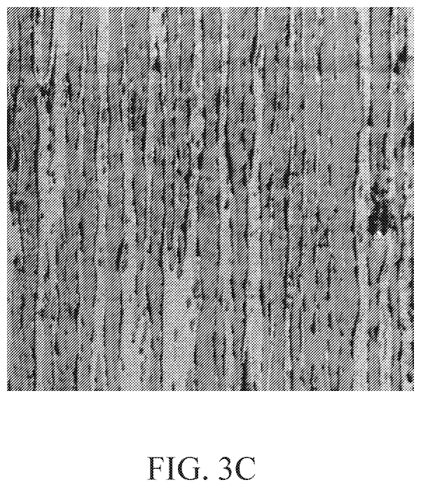

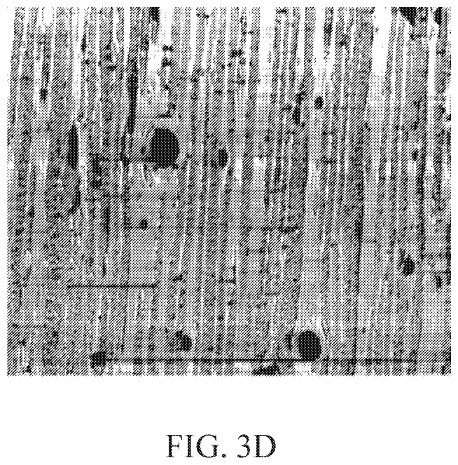

With reference to FIG. 3A, a plot 300 is shown of miscible blend and series permeability models 302 and 304, respectively, obtained using the relevant control values as parameters in Equations (1) and (2) previously mentioned. It should be noted that, to simplify model calculations herein, functional polyolefin compatibilizer is replaced by the corresponding polyolefin component in the model calculations (e.g., HDPE is used in calculations instead of Orevac 18360), as the compatibilizer's properties (density and gas barrier) are comparable to the polyolefin component.

With continuing reference to FIG. 3A, a measured permeability value for Film 3 of 0.56 cc·mil/100 in2·day·atm is plotted against the corresponding series and miscible blend models, shown by data point 306 in FIG. 3B. Reviewing the plot illustrates that measured value 306 is in line with the series model, and therefore indicates a layer-like morphology.

With reference to FIG. 3B, a plot 310 is shown of miscible blend and series permeability models 312 and 314, respectively, obtained using the relevant control values previously mentioned. A measured permeability value for Film 4 of 0.92 cc·mil/100 in2·day·atm is plotted against the corresponding series and miscible blend models, as shown by data point 316 in FIG. 3B. Comparing the relative proximity of the measured value to the miscible blend model and series model values indicates Film 4 to have layer-like morphology.

The morphology of Films 3 and 4 is also investigated using AFM. AFM images are taken from the extruded direction (i.e., from a plane parallel to the extruded direction) and illustrated in FIGS. 3C and 3D (image scale is 10 μm). As shown in these figures, the HDPE/EVOH blown film (Film 3) and PP/EVOH cast film (Film 4) both exhibit layer-like morphology, as demonstrated by the alternating phases of the barrier polymer (EVOH) and structural polymer (HDPE or PP), illustrated by having different grayscale values, that are elongated, discrete, layer-like domains.

As previously noted, layer-like morphology is surprisingly maintained despite the use of compatibilizer, as indicated by the permeability data. This is surprising because the use of compatibilizer would otherwise be expected to cause a decrease of interfacial tension as well as a reduction of domain size, leading to a material disruption of the layer-like morphology, or causing a different morphology altogether, such as a droplet/rodlike or co-continuous morphology. This does not appear to be the case, however, as layer-like morphology is not disrupted here. For example, Film 3 (47.5 wt % HDPE, 47.5 wt % EVOH and 5 wt % maleic anhydride modified LLDPE compatibilizer) still yields very good gas barrier properties. Its layer-like morphology is confirmed by both AFM image and the oxygen permeability.

Without wishing to be bound by theory, the layer-like morphology formed during the extrusion process is a result of a “semi-self-assembly” phenomenon, where immiscibility and incompatibility between major components are the internal drive for phase separation, resulting in layer-like morphology. As noted, addition of a compatibilizer improves processability (and enhances compatibility) that otherwise results from component incompatibility without materially disrupting the advantageous layer-like morphology.

### Example 3

This example studies the use of a compounded masterbatch approach, as opposed to in-line direct delivery of components to the extruder. A monolayer film, referenced as EX Film 1, is cast in the same manner as that previously described for Film 1, except that it is cast directly from a dry blend mixture of 50 wt. % LLDPE (LL 3001 from ExxonMobil Chemical) and 50 wt. % EVOH (Eval E171 from Kuraray Co., Ltd), instead of from a masterbatch formed therefrom.

Oxygen permeability of the EX Film 1 is measured using a Mocon® Ox-Tran® 2/21L unit at 23° C. with 0% relative humidity. The result is listed in below alongside the data previously shown in relation to Example 1, for comparison purposes:

| | P(O₂) | Series Model P(O₂) | Blend Model P(O₂) |
|---|---|---|---|
| | cc · mil/ | cc · mil/ | cc · mil/ |
| Film | 100 in² · day · atm | 100 in² · day · atm | 100 in² · day · atm |
| LLDPE cast | 617.9 | / | / |
| control | | | |
| HDPE cast | 67.5 | / | / |
| control | | | |
| EVOH cast | 0.243 | / | / |
| control | | | |
| EX Film 1 | 0.81 | 0.54 | 18.7 |
| (dry blend) | | | |
| Film 1 (MB1) | 0.61 | 0.54 | 18.7 |
| Film 2 (MB2) | 0.61 | 0.54 | 18.7 |

Testing results show that a film formed from a masterbatch (Film 1) has better barrier properties than a film formed form a dry blend—directly from the constituent components of the masterbatch (EX Film 1). While not wishing to be bound by theory, one reason for this may be that layer-like morphology is materially affected by the distribution of components, and pre-compounding (i.e., compounding the constituent components effectively into a masterbatch, such as via twin screw or FCM compounding extruder) ensures sufficient mixing of the components. Then, during subsequent extrusion (e.g., film extrusion) the well-mixed components can evenly redistribute to form layer-like morphology as a result of phase separation. This process is believed to be assisted by extrusion shear forces to some degree. The overall process may be referenced as “semi-self-assembly”.

### Example 4.1

Because of the demonstrated advantage of using functionalized polyolefin, a study of compatibilizers is performed as outlined below. Oxygen permeability of the following monolayer films was tested at 23° C. and 0% relative humidity using a MOCON 2/21 L unit. These film samples are based on MB4 with unchanged amount of EVOH, while increasing the compatibilizer from 1% to 20%.

| | | | | | | | P (O₂) | P (O₂) |
|---|---|---|---|---|---|---|---|---|
| | | | | | | P (O₂) | Est. based | Est. based on |
| Sample | | | | Compounding | Cast Film | cc.mil/ | on series | miscible blend |
| ID | Barrier MB Composition | | | Processing | Processing | 100 inch²·day | model | model |
| Film | 25% | 55% | 20% | OK | Poor | Not testable | 0.50 | 6.44 |
| 4.101 | PP3371 | EVOH | Orevac | | appearance | | | |
| | | E171 | CA 100 | | | | | |
| Film | 30% | 55% | 15% | OK | Ok, Cannot | Test failed, | 0.50 | 6.44 |
| 4.102 | PP3371 | EVOH | Orevac | | get 1 mil | implying weak | | |
| | | E171 | CA 100 | | | barrier | | |
| Film | 35% | 55% | 10% | OK | OK, Cannot | Test failed, | 0.50 | 6.44 |
| 4.103 | PP3371 | EVOH | Orevac | | get 1 mil | implying weak | | |
| | | E171 | CA 100 | | | barrier | | |
| Film | 40% | 55% | 5% | OK | No comment | ~0.70 | 0.50 | 6.44 |
| 4.104 | PP3371 | EVOH | Orevac | | | | | |
| | | E171 | CA 100 | | | | | |
| Film | 42% | 55% | 3% | OK | Poor | Not testable | 0.50 | 6.44 |
| 4.105 | PP3371 | EVOH | Orevac | | appearance | | | |
| | | E171 | CA 100 | | | | | |
| Film | 44% | 55% | 1% | OK | Poor | Not testable | 0.50 | 6.44 |
| 4.106 | PP3371 | EVOH | Orevac | | appearance | | | |
| | | E171 | CA 100 | | | | | |

Results illustrate that for this masterbatch, films have poor processability until more than about 3% compatibilizer is present. Without wishing to be bound by theory, these results may demonstrate that the incompatibility between polypropylene and EVOH dominates below about 3 wt. % loading, resulting in poor interfacial adhesion between major components. On the other hand, when compatibilizer amount exceeds about 10 wt. %, a material disruption of layer-like morphology is believed to have occurred, resulting in the films samples losing their oxygen gas barrier properties.

### Example 4.2

The prior example is continued in which monolayer films have a fixed ratio of EVOH over PP, along with various compatibilizer amounts.

| | | | | | | | P (O₂) | P (O₂) |
|---|---|---|---|---|---|---|---|---|
| | | | | | | P (O₂) | Est. based | Est based on |
| Sample | | | | Compounding | Cast Film | cc.mil/ | on series | miscible |
| ID | Barrier MB Composition | | | Processing | Processing | 100 in²·day | model | blend model |
| Film | 34% | 46% EVOH | 20% | OK | OK | Test failed, | 0.61 | 12.94 |
| 4.201 | PP3371 | E171 | Orevac | | | implying weak | | |
| | | (~0.40 volume) | CA 100 | | | barrier | | |
| Film | 36% | 49% EVOH | 15% | OK | OK | Test failed, | 0.56 | 10.61 |
| 4.202 | PP3371 | E171 | Orevac | | | implying weak | | |
| | | (~0.43 volume) | CA 100 | | | barrier | | |
| Film | 38% | 52% EVOH | 10% | OK | OK | Test failed, | 0.54 | 9.29 |
| 4.203 | PP3371 | E171 | Orevac | | | implying weak | | |
| | | (~0.45 volume) | CA 100 | | | barrier | | |
| Film | 41% | 56% EVOH | 3% | OK | OK | Inconsistent | 0.49 | 6.67 |
| 4.204 | PP3371 | E171 | Orevac | | | results | | |
| | | (~0.50 volume) | CA 100 | | | | | |
| Film | 42% | 57% EVOH | 1% | Cannot make | / | / | 0.48 | 6.24 |
| 4.205 | PP3371 | E171 | Orevac | | | | | |
| | | (~0.51 volume) | CA 100 | | | | | |

Similar results have been observed. This time, with less than 3 wt. % of compatibilizer, the blend cannot be processed during compounding due to the incompatibility between PP and EVOH. With 3 wt. % compatibilizer present, films are made but without good uniformity. With more than about 10 wt. % compatibilizer present, the blends again lose their gas barrier properties. This example shows compatibilizer is helping in improving the interfacial adhesion between PP and EVOH, but simultaneously affects the morphology of such a blend.

### Example 5

This example explores whether barrier masterbatches disclosed herein may be used in a multilayer structure. The barrier masterbatch of the first embodiment produced in Example 1 (MB1) is coextruded with LLDPE, LDPE and HDPE to form three multilayer coextruded cast films, respectively, each of which comprises three layers. The first film (Film 5.1) comprises an upper layer of LLDPE, a middle or core layer of MB1 and a lower layer of LLDPE, with the middle layer comprising 80% of the first film and each of the upper and lower layers comprising 10% of the first film. The second film (Film 5.2) comprises an upper layer of LDPE, a middle or core layer of MB1 and a lower layer of LDPE, with the middle layer comprising 80% of the second film and each of the upper and lower layers comprising 10% of the second film. The third film (Film 5.3) comprises an upper layer of HDPE, a middle or core layer of MB1 and a lower layer of HDPE, with the middle layer comprising 80% of the third film and each of the upper and lower layers comprising 10% of the third film.

Oxygen permeability and water vapor transmission rate is measured as described in prior examples, with test relative humidity as indicated. The results are as follows:

| | Film | | |
|---|---|---|---|
| | Film 5.1 | Film 5.2 | Film 5.3 |
| Layer Distribution (%) | 10/80/10 | 10/80/10 | 10/80/10 |
| Upper/Core/Lower | LLDPE/MB1/ | LDPE/MB1/ | HDPE/MB1/ |
| | LLDPE | LDPE | HDPE |
| WVTR g · mil/ | 1.58 ± 0.07 | 1.35 ± 0.06 | 0.7 ± 0.01 |
| 100 inch² · day · atm | | | |
| P(O₂) (0% RH) cc · mil/ | 0.78 | 0.69 | 0.69 |
| 100 inch² · day · atm | | | |
| P(O₂) (90% RH) cc · mil/ | 1.70 | 1.50 | 1.42 |
| 100 inch² · day · atm | | | |

The results of this example indicate that the barrier masterbatches described herein may be used to form cast multilayer packaging films having good barrier properties.

### Example 6

Barrier masterbatch MB3 (47.5% HDPE, 47.5% EVOH, and 5% maleic anhydride modified LLDPE compatibilizer) is investigated for performance and morphology when used in different layers of coextruded multilayer blown films. Blown film samples are produced by a 5-layer blown film line at about 200-230° C. The blown film layer structure and composition of samples are set forth in the table below, in which Extruder A may be considered the outside skin layer, Extruders B and D may be considered interlayers, Extruder C may be considered the core layer, and Extruder E may be considered the inner layer. Percentages indicate layer distribution percentages (% of the blown film thickness), and the constituent resins are selected from the following: HDPE (ExxonMobil HTA 108), maleic anhydride grafted polyethylene (Admer 518E), LDPE (ExxonMobil LD100), and EVOH (Eval E171 from Kuraray Co., Ltd):

| | | | | | | Film Thickness |
|---|---|---|---|---|---|---|
| | Extruder A | Extruder B | Extruder C | Extruder D | Extruder E | (μm) |
| Film 6.1 | 30% | 10% | 10% | 10% | 40% LD100 | 75 |
| | HDPE | tie 518E | EVOH E171 | tie 518E | | |
| Film 6.2 | 30% | 10% | 10% | 10% | 40% LD100 | 75 |
| | HDPE | tie 518E | MB3 | tie 518E | | |
| Film 6.3 | 20% | 10% | 20% | 10% | 40% LD100 | 75 |
| | HDPE | tie 518E | MB3 | tie 518E | | |
| Film 6.4 | 16% | 10% | 30% | 10% | 34% LD100 | 50 |
| | HDPE | tie 518E | MB3 | tie 518E | | |
| Film 6.5 | 30% | 20% | 20% | 20% | 10% LD100 | 75 |
| | HDPE | EVOH E171 | LD100 | LD100 | | |
| Film 6.6 | 30% | 20% | 20% | 20% | 20% LD100 | 75 |
| | HDPE | MB3 | LD100 | LD100 | | |
| Film 6.7 | 20% | 30% | 10% | 20% | 20% LD100 | 75 |
| | MB3 | HDPE | HDPE | LD100 | | |
| Film 6.8 | 20% | 10% | 30% | 20% | 20% LD100 | 75 |
| | MB3 | tie 518E | LD100 | LD100 | | |
| Film 6.9 | 30% | 10% | 10% | 10% | 40% LD100 | 75 |
| | HDPE | MB3 | LD100 | MB3 | | |

| | | | |
|---|---|---|---|
| Film 6.10 | 20% | 80% HDPE | 75 |
| | MB3 | | |

Water vapor transmission rate and oxygen permeability are measured for the samples and the results are as follows:

| | P(O₂) (0% RH) | WVTR |
|---|---|---|
| | cc · mil/100 in² · day · atm | g · mil/100 in² · day · atm |
| Film 6.1 | 0.93 | 0.487 |
| Film 6.2 | 3.51 | 0.464 |
| Film 6.3 | 2.47 | 0.506 |
| Film 6.4 | 1.81 | 0.548 |
| Film 6.5 | * | * |
| Film 6.6 | 2.1 | 0.385 |
| Film 6.7 | 5.37 | 0.40 |
| Film 6.8 | 3.91 | 0.76 |
| Film 6.9 | 3.39 | 0.45 |
| Film 6.10 | 7.12 | 0.26 |

It is noted that Sample 6.5 has extremely poor adhesion between layers.

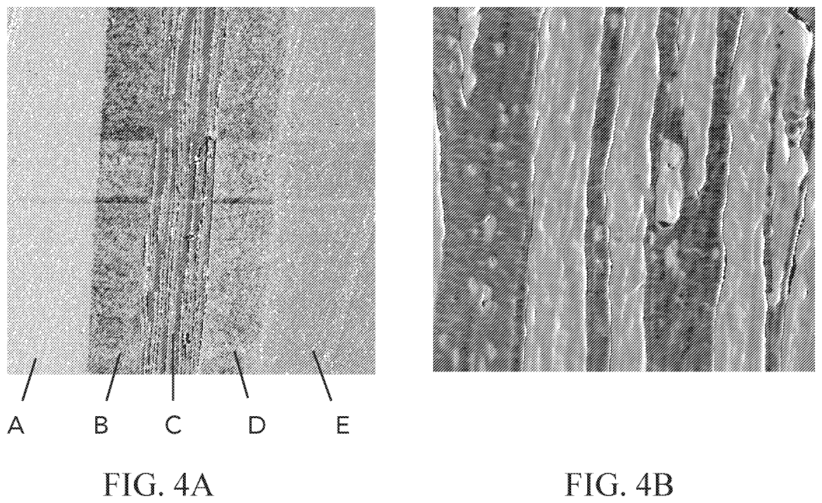

In addition, illustrations of atomic force microscopy images of Film 6.2 are provided as FIGS. 4A & 4B. FIG. 4A shows a cross section comprising outside skin layer “A”, interlayers “B” and “D”, core layer “C”, and inner layer “E”, where the core layer C comprises MB3. FIG. 4A has a cross-image scale of 50 μm. FIG. 4B illustrates a 10× magnification of core layer C shown in FIG. 4A. The AFM images show that a layer-like morphology is present for the core layer, indicating that the masterbatches described herein are suitable for use in multilayer blown films. Films 6.2-6.4 have MB3 in core layer with tie layer resins surrounding. Film 6.6 has MB3 in core layer with no tie layer resins. Films 6.7, 6.8, and 6.10 have MB3 in an outside skin layer and Film 6.9 has MB3 in the interlayers.

### Example 7

Barrier masterbatch MB4 (40% iPP, 55% EVOH, and 5% maleic anhydride modified PP compatibilizer) is investigated for use as a layer in a biaxially oriented BOPP multilayer (3 layer) film. The coextruded film layer structure and compositions are set forth in the table below, in which Layers A and C may be considered the skin layers, percentages indicate layer distribution percentages (% of the total film thickness), and the PP resin is Eltex® 100GD03 from INEOS.

| | | | | Film |
|---|---|---|---|---|
| | Layer | Layer | Layer | Thickness |
| | A | B | C | (μm) |
| Film 7.1 | PP | PP | PP | 30 |
| PP control | | | | |
| Film 7.2 | PP | MB4 | PP | 34 |
| | (16.7%) | (66.4 %) | (16.9%) | |
| Film 7.3 | MB4 | PP | PP | 29 |
| | (12.4%) | | | |

Biaxially oriented films are produced on a BOPP pilot line (tenter frame; sequential stretch) with an MDO and TDO providing draw ratios of ˜4×9, respectively. Oxygen permeability and water vapor transmission rate are measured for the oriented film samples, and the results are as follows:

| | P(O₂) (0% RH) | P(O₂) (90% RH) | WVTR (100% RH) |
|---|---|---|---|
| | cc · mil/ | cc · mil/ | g · mil/ |
| | 100 in² · day · atm | 100 in² · day · atm | 100 in² · day · atm |
| Film 7.1 | 97.56 | 94.18 | 0.381 |
| PP control | | | |
| Film 7.2 | 1.88 | 2.00 | 0.457 |
| Film 7.3 | 15.57 | 16.9 | 0.421 |

The results of this example indicate that the barrier masterbatches described herein can be used to form biaxially oriented multilayer packaging films having good barrier properties.

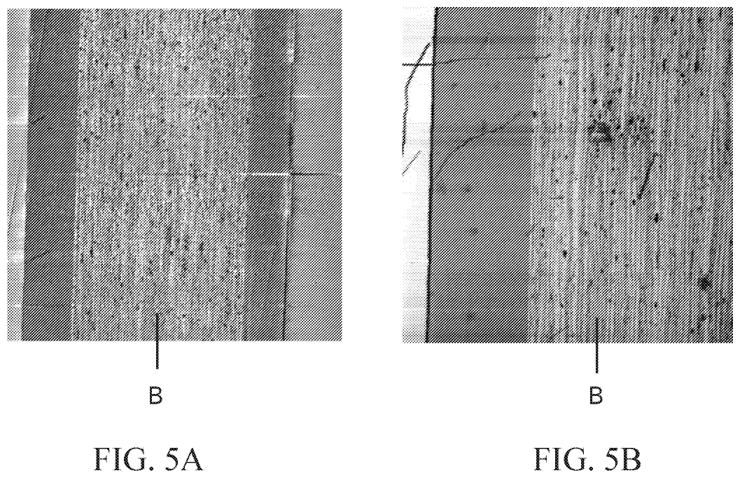

In addition, illustrations of atomic force microscopy images of the oriented Film 7.2 are provided as FIGS. 5A & 5B. FIG. 5A shows a cross section comprising skin and core layers, where core Layer B comprises MB4. FIG. 5A has a cross-image scale of 50 μm. FIG. 5B illustrates a 2× magnification of the image illustrated in FIG. 5A.

The AFM images show that a layer-like morphology is present for the core layer, a result that indicates layer-like morphology produced by the extrusion of MB4 remains even after robust biaxial orientation. It is worth noting that no tie layers were required to fabricate the samples. Also worth noting is the fact that MB4 was used as both a core layer (Film 7.2) and a skin layer (Film 7.3) in a multilayer film. By comparing with BOPP control film (Film 7.1), one can see that the oxygen barrier is improved greatly in the multilayer films having a layer comprised of MB4. In addition, such films keep suitably high oxygen barrier properties at higher relative humidity.

### Example 8

Barrier masterbatch MB4 (40% iPP, 55% EVOH, and 5% maleic anhydride modified PP compatibilizer) is investigated for use in a biaxially oriented BOPP multilayer (5 layer) film. The coextruded film layer compositions of samples are set forth in the table below, in which Layer A may be considered an outside skin layer, Layers C may be considered interlayers or tie layers, and Layer B may be considered the core layer. Percentages indicate layer distribution percentages (% of the total film thickness), and the PP resin is Eltex® 100GD03 from INEOS. The tie resin is a 50/50 blend of anhydride-modified PP (DuPont™ Bynel 50E739) and Eltex® 100GD03 from INEOS.

| | | | | | | Film |
|---|---|---|---|---|---|---|
| | Layer | Layer | Layer | Layer | Layer | Thickness |
| | A | C | B | C | A | (μm) |
| Film 8.1 | PP | PP | PP | PP | PP | 30 |
| PP Control | | | | | | |
| Film 8.2 | PP | tie | MB4 | tie | PP | 26 |
| | (10.4%) | (13.8%) | (52%) | (14%) | (9.8%) | |
| Film 8.3 | PP | MB4 | PP | MB4 | PP | 28 |
| | (11%) | (11.4%) | (53.9%) | (12.6%) | (11.1%) | |
| Film 8.4 | MB4 | tie | PP | tie | MB4 | 28 |
| | (10.9%) | (10.4%) | (54.6%) | (11.4%) | (12.7%) | |

Biaxially oriented films are produced on a BOPP pilot line (tenter frame; sequential stretch) with an MDO and TDO providing draw ratios of ˜4×9, respectively. Water vapor transmission rate, and oxygen permeability are measured, and the results are as follows:

| | WVTR | P(O₂) (0% RH) | P(O₂) (90% RH) |
|---|---|---|---|
| | g · mil/ | cc · mil/ | cc · mil/ |
| | 100 in² · day · atm | 100 in² · day · atm | 100 in² · day · atm |
| Film 8.1 | 0.381 | 97.56 | 94.18 |
| Film 8.2 | 0.533 | 2.62 | 2.91 |
| Film 8.3 | 0.394 | 6.40 | 6.98 |
| Film 8.4 | 0.482 | 8.50 | 9.06 |

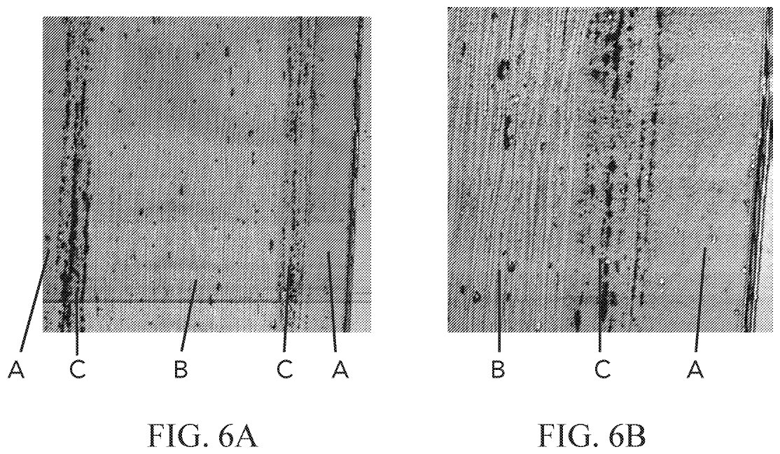

In addition, illustrations of atomic force microscopy images of Films 8.2 and 8.3 are provided as FIGS. 6 and. 7, respectively.

FIG. 6A shows a cross section of Film 8.2 comprising skin layers A, tie layers C, and core layer B, where the core layer comprises MB4. FIG. 6A has a cross-image scale of 25 μm, while FIG. 6B has a cross-image scale of 10 μm.

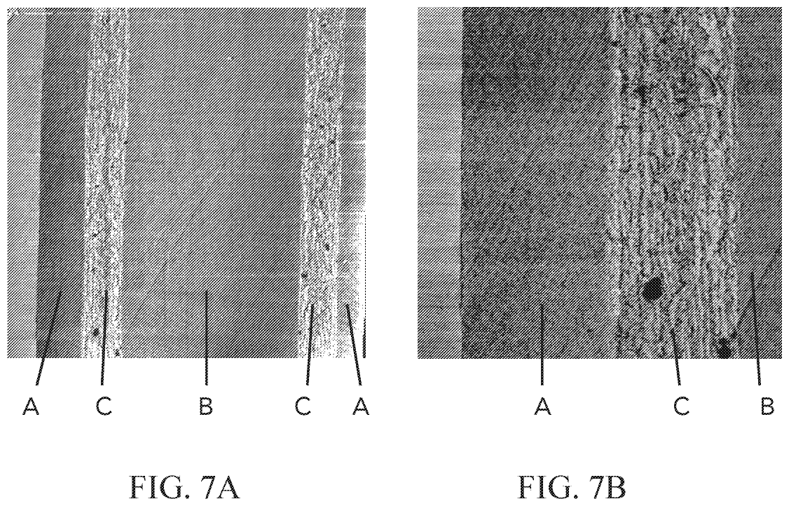

FIG. 7A shows a cross section of Film 8.3 comprising skin layers A, interlayers C, and core layer B, where interlayers C comprise MB4. FIG. 7A has a cross-image scale of 30 μm, while FIG. 7B has a cross-image scale of 10 μm.

The AFM images show that a layer-like morphology is present for core layer “B” in Film 8.2 and interlayers “C” in Film 8.3, indicating that the barrier masterbatches herein are suitable for use at different positions (core, interlayer or skin layer) in a multilayer BOPP film. Further, they indicate that the layer-like morphology produced by the extrusion of MB4 remains even after robust biaxial orientation. It is worth noting that MB4 may be used to form a core layer (Film 8.2), interlayers (Film 8.3), and skin layers (Film 8.4) in a multilayer film. By comparing with BOPP control film (Film 8.1), one can see that the oxygen barrier is improved greatly in the multilayer films having either a core layer, interlayers, or skin layers comprised of MB4. In addition, such films keep suitably high oxygen barrier properties at higher relative humidity.

As described and shown herein, using one or more barrier masterbatches to form one or more layers with layer-like morphology allows one to produce barrier film or products in a manner that does not require numerous extruders and/or expensive equipment. Indeed, as demonstrated above, a monolayer film having good barrier properties may be formed from a masterbatch comprising a select blend of components using only one extruder, and three and five-layer multilayer films having good barrier properties may be formed using said masterbatch to feed skin, interlayer, and/or core layer extruders. Also, in addition to reducing the amount of required equipment and/or allowing for more flexible multilayer film design, the use of such a masterbatch to form barrier films allows for the potential to eliminate the need for tie resins. Surprisingly, the addition of compatibilizer to masterbatches enables the formation of processable film or product that possesses layer-like morphology.

It is to be understood that the exemplary embodiment(s) described herein is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

What is claimed is:

1. A method of forming a polymeric body having enhanced barrier properties to a permeant of interest, comprising:
providing a masterbatch comprising from 30 to 70 weight percent of a structural polymer, from 30 to 70 weight percent of a barrier polymer for the permeant of interest, and from about 3 to about 10 weight percent of a functionalized polyolefin;
melting the masterbatch in a first heated extruder;
extruding the melted masterbatch to form the polymeric body comprising the structural polymer, the barrier polymer and the functionalized polyolefin, wherein the body possesses a layer-like morphology.

2. A method of forming barrier film for a permeant of interest, comprising:
providing a masterbatch comprising from 30 to 70 weight percent of a structural polymer, from 30 to 70 weight percent of a barrier polymer, and from about 3 to about 10 weight percent functionalized polyolefin;
melting the masterbatch in a heated extruder;
passing the melted masterbatch through a die to form a molten polymer extrudate; and
cooling the molten polymer extrudate to form a barrier film having a layer-like morphology.

3. The method according to claim 1 wherein the polymeric body comprises a first barrier film layer, wherein the melted masterbatch is extruded through a die to form a first molten extrudate, the method further comprising:
cooling and thinning the first molten extrudate to form the first barrier film layer having the layer-like morphology.

4. The method according to claim 2 for forming a multilayer barrier film for the permeant of interest, the method further comprising:
providing a second polymer;
melting the second polymer in a second heated extruder;
coextruding the melted masterbatch and the melted second polymer through the die to form a molten multilayer polymer extrudate; and
cooling the molten multilayer polymer extrudate to form the multilayer barrier film comprising the first barrier film layer and a second layer, wherein the first barrier film layer has a layer-like morphology.

5. The method of claim 4, wherein the second polymer is selected from the group consisting of polyolefins, polyamides, polyesters, polystyrene, polylactic acid, polyhydroxyalkanoate and combinations thereof.

6. The method of claim 1, wherein the structural polymer is selected from a group consisting of polyolefins, polyesters, polystyrene, polylactic acid, polyhydroxyalkanoate and combinations thereof, and wherein the barrier polymer is selected from a group consisting of copolymers of ethylene vinyl alcohol, polyvinyl alcohol, polyvinylidene chloride, polyamides, nitrile polymers and combinations thereof.

7. (canceled)

8. (canceled)

9. (canceled)

10. The method of claim 2, wherein a molten multilayer polymer extrudate is formed and wherein the polyolefin comprises polypropylene homopolymer or copolymer, wherein the cooling of the molten multilayer polymer extrudate forms an unstretched barrier film, and further comprising the step of biaxially stretching the unstretched barrier film to form a stretched barrier film that has a thickness that is less than the thickness of the unstretched barrier film, and wherein the stretched barrier film possesses layer-like morphology.

11. The method of claim 1, wherein the permeant is oxygen and wherein the masterbatch comprises from 35 to 65 weight percent of the structural polymer and from 35 to 65 weight percent of the barrier polymer and wherein the masterbatch comprises from 5 to 10 weight percent of the functionalized polyolefin.

12. The method of claim 1, the functionalized polyolefin is selected from a group consisting of copolymers of ethylene and/or propylene and one or more unsaturated polar monomers, and polyolefins that are graft-modified with a maleic acid or a maleic anhydride.

13. (canceled)

14. (canceled)

15. (canceled)

16. (canceled)

17. The method of claim 1, wherein the polymeric body is selected from the group consisting of a packaging film, a film for packaging food, a film for packaging pharmaceutical or healthcare products, a lidding film, an agricultural film, an industrial film, a tubing, a pipe, a cap, a closure, a film for silage, a film for fumigation or mulch, a three dimensional body, a container, a bottle, a pouch, a tank, and a package for food, beverage or for an industrial, pharmaceutical or cosmetic product.

18. A polymeric body having enhanced barrier properties to a permeant of interest, the body comprising from 30 to 70 weight percent structural polymer, from 30 to 70 weight percent barrier polymer for the permeant of interest, and from about 3 to about 10 weight percent functionalized polyolefin, wherein the body possesses layer-like morphology.

19. The polymeric body of claim 18, wherein the polymeric body is selected from the group consisting of a packaging film, a film for packaging food, an agricultural film, an industrial film, a tubing, a pipe, a cap, a closure, a film for silage, a film for fumigation or mulch, a three dimensional body, a container, a bottle, a pouch, a tank, and a package for food, beverage or for an industrial, pharmaceutical or cosmetic product.

20. (canceled)

21. The polymeric body of claim 18, wherein the polymeric body is a barrier film, wherein the barrier film comprises from 35 to 65 weight percent of the structural polymer, from 35 to 65 weight percent of the barrier polymer, and from 5 to 10 weight percent of the functionalized polyolefin.

22. A multilayer barrier film comprising the barrier film of claim 21 with at least one second layer, the second layer comprised of a second polymer, wherein the first barrier layer possesses layer-like morphology.

23. The multilayer barrier film according to claim 22 wherein the second polymer is selected from the group consisting of polyolefins, polyamides, polyesters, polystyrene, polylactic acid, polyhydroxyalkanoate and combinations thereof.

24. The method of claim 2, wherein the structural polymer is selected from a group consisting of polyolefins, polyesters, polystyrene, polylactic acid, polyhydroxyalkanoate and combinations thereof, and wherein the barrier polymer is selected from a group consisting of copolymers of ethylene vinyl alcohol, polyvinyl alcohol, polyvinylidene chloride, polyamides, nitrile polymers and combinations thereof.

25. The method of claim 2, wherein the permeant is oxygen and wherein the masterbatch comprises from 35 to 65 weight percent of the structural polymer and from 35 to 65 weight percent of the barrier polymer and wherein the masterbatch comprises from 5 to 10 weight percent of the functionalized polyolefin.

26. The method of claim 2, wherein the functionalized polyolefin is selected from a group consisting of copolymers of ethylene and/or propylene and one or more unsaturated polar monomers, and polyolefins that are graft-modified with a maleic acid or a maleic anhydride.
